(19) United States
(12) Patent Application Publication
(10) Pub. No.: US 2025/0321785 A1
(43) Pub. Date: Oct. 16, 2025

(54) SCHEDULING METHOD, APPARATUS, DEVICE AND STORAGE MEDIUM

(71) Applicant: Lemon Inc., Grand Cayman (KY)

(72) Inventors: Lelin ZHANG, Los Angeles, CA (US); Chiliang YANG, Beijing (CN); Zuyao JIANG, Beijing (CN); Xing MEI, Los Angeles, CA (US)

(21) Appl. No.: 18/866,429

(22) PCT Filed: May 5, 2023
(86) PCT No.: PCT/SG2023/050309

§ 371 Date: Nov. 15, 2024

(30) Foreign Application Priority Data
May 16, 2022 (CN) 202210527828.7

(51) Int. Cl. G06F 9/48; G06F 9/30

(52) U.S. Cl. CPC G06F 9/4881; G06F 9/3009; G06F 9/485; G06F 2209/486

(57) ABSTRACT

The embodiment discloses a scheduling method, apparatus, device and storage medium. The method includes: obtaining an algorithm directed graph corresponding to a target task, the algorithm directed graph comprising a plurality of algorithm nodes; grouping the plurality of algorithm nodes in the algorithm directed graph to obtain a plurality of node groups; scheduling the plurality of node groups in series, and scheduling a processing algorithm corresponding to at least one algorithm node in the node group in parallel.

This disclosure claims priority to Chinese Patent Application No. 202210527828.7, filed on May 16, 2022, the entire contents of which are incorporated herein by reference.

### FIELD

The embodiment of the disclosure relates to the technical field of computers, in particular to a scheduling method, apparatus, device and a storage medium.

### BACKGROUND

With the rapid development of computer vision and graphics, rich and diverse images may be generated by artificial intelligence (e.g., machine learning or deep learning) and virtual augmented reality technology.

It is usually necessary to call a plurality of algorithms to implement an image processing task. In the related art, the algorithms are sequentially executed in a certain order, which affects the throughput rate and the calculation efficiency of the whole task.

### SUMMARY

The embodiment of the disclosure provides a scheduling method, apparatus, device, and storage medium, which may schedule algorithm nodes in parallel, and improve the throughput rate and the calculation efficiency during target task processing.

According to a first aspect, an embodiment of the disclosure provides a scheduling method, comprising:

obtaining an algorithm directed graph corresponding to a target task, the algorithm directed graph comprising a plurality of algorithm nodes;

grouping the plurality of algorithm nodes in the algorithm directed graph to obtain a plurality of node groups;

scheduling the plurality of node groups in series, and scheduling a processing algorithm corresponding to at least one algorithm node in the node group in parallel.

According to a second aspect, an embodiment of the disclosure further provides a scheduling apparatus, comprising:
an algorithm directed graph obtaining module, configured to obtain an algorithm directed graph corresponding to a target task, the algorithm directed graph comprising a plurality of algorithm nodes;
an algorithm node grouping module, configured to group the plurality of algorithm nodes in the algorithm directed graph to obtain a plurality of node groups;
a scheduling module, configured to schedule the plurality of node groups in series, and schedule a processing algorithm corresponding to at least one algorithm node in the node groups in parallel.

According to a third aspect, an embodiment of the disclosure further provides an electronic device, comprising:
one or more processing devices;
a storage device configured to store one or more programs;
wherein the one or more programs, when executed by the one or more processing devices, cause the one or more processing devices to implement the scheduling method of embodiments of this disclosure.

According to a fourth aspect, an embodiment of the disclosure further provides a computer-readable medium having a computer program stored thereon, wherein the computer program, when executed by a processing device, implements the scheduling method of embodiments of this disclosure.

### BRIEF DESCRIPTION OF DRAWINGS

FIG. 1 is a flowchart of a scheduling method according to an embodiment of the present disclosure;

FIG. 2 is an example diagram of an algorithm directed graph according to an embodiment of the present disclosure;

FIG. 3 is an example diagram of an algorithm directed graph according to an embodiment of the present disclosure;

FIG. 4 is an example diagram of grouping algorithm nodes according to an embodiment of the present disclosure;

FIG. 5 is an example diagram of grouping algorithm nodes according to an embodiment of the present disclosure;

FIG. 6 is an example diagram of algorithm scheduling according to an embodiment of the present disclosure;

FIG. 7 is a schematic structural diagram of a scheduling apparatus according to an embodiment of the present disclosure;

FIG. 8 is a schematic structural diagram of an electronic device according to an embodiment of the present disclosure.

### DETAILED DESCRIPTION

Embodiments of the present disclosure will be described below with reference to the accompanying drawings. While certain embodiments of the present disclosure are shown in the drawings, it should be understood that the present disclosure may be implemented in various forms. It should be understood that the drawings and embodiments of the present disclosure are for exemplary purposes only.

It should be understood that the steps recited in the method embodiments of the present disclosure may be performed in different orders, and/or in parallel. Further, the method embodiments may include additional steps and/or omit performing the illustrated steps.

As used herein, the term “comprising” and deformation thereof are open-ended, i.e., “including but not limited to”. The term “based on” means “based at least in part on”. The term “one embodiment” means “at least one embodiment”; the term “another embodiment” means “at least one further embodiment”; and the term “some embodiments” means “at least some embodiments”. The relevant definition of other terms will be given below.

It should be noted that concepts such as “first” and “second” mentioned in this disclosure are merely used to distinguish different apparatuses, modules, or units, and are not intended to limit the order of functions performed by the apparatuses, modules, or units or the mutual dependency relationship.

It should be noted that the modification of “a” and “a plurality of” mentioned in this disclosure is illustrative, and those skilled in the art should understand that “one or more” should be understood unless the context clearly indicates otherwise.

The names of messages or information interacted between a plurality of devices in embodiments of this disclosure are for illustrative purposes only and are not intended to limit the scope of such messages or information.

Intelligent creation: an image video content generation method based on computer vision and graphics used in a video type social platform, which enables video content provided by a user to have more abundant content by an application of artificial intelligence (such as traditional machine learning or deep learning) and virtual reality/augmented reality technology.

Algorithm platform: a software system supporting algorithm scheduling and execution when a user uses a mobile platform or other personal computer (PC) platform to perform intelligent creation, an input of the system is picture or video information from a camera and algorithms required to be run, an execution sequence and a dependency relationship of the algorithms are described and connected through a directed graph, and an output of the system is a result of an algorithm running, including image classification information, a target object detection bounding box and confidence, object segmentation information, a generated image, a human body or object key point information, and the like.

Parallel asynchronous framework: a software optimization framework based on a central processing unit (CPU) multi-thread acceleration or other hardware, and the main role of the framework is to improve the overall throughput and computational efficiency of the system by disassembling and dynamically allocating tasks that can be executed concurrently under the support of multi-thread technology.

On the current intelligent creation computing platform, for each image, each computing node in the algorithm diagram is executed in a sequential manner, and there is no cache of multi-frame results between nodes, resulting in a potential waste of computing resources.

FIG. 1 is a flowchart of a scheduling method according to Embodiment 1 of the present disclosure, wherein this embodiment may be applicable to a case in which algorithm nodes in algorithm diagram may be scheduled in parallel. The method may be performed by a scheduling apparatus. The apparatus may be composed of hardware and/or software, and may generally be integrated into a device having a scheduling method function, wherein the device may be an electronic device such as a server, a mobile terminal, or a server cluster. As shown in FIG. 1, the method may include the following steps:
S110: obtain an algorithm directed graph corresponding to a target task.

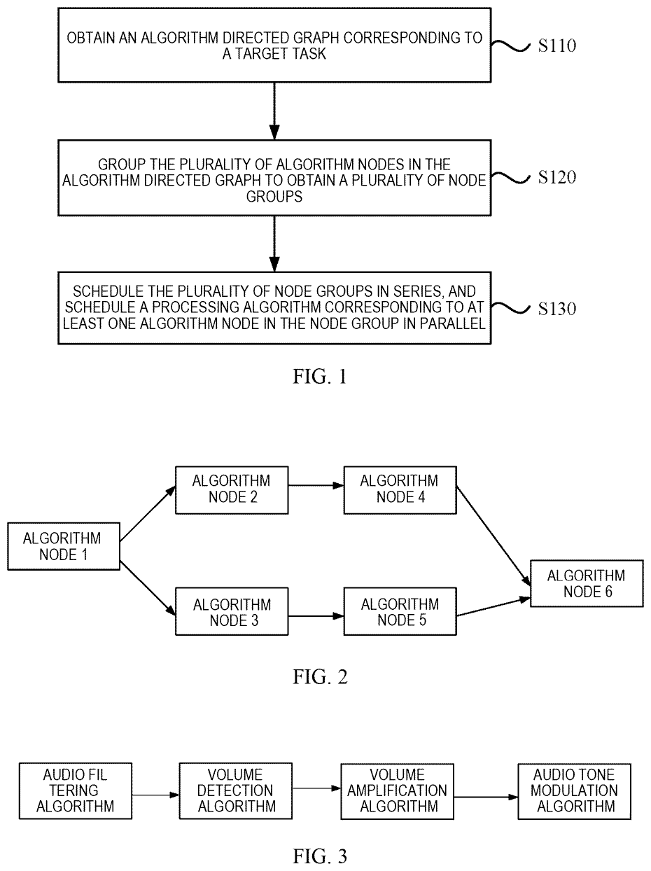

The algorithm directed graph may comprise a plurality of algorithm nodes, which are connected by directed edges. The algorithm nodes at both ends of the directed edge have a dependency relationship. The algorithm node at the finishing end of the directed edge depends on the algorithm node of the starting end. For example, FIG. 2 is an example diagram of an algorithm directed graph in this embodiment. As shown in FIG. 2, the algorithm directed graph comprises 6 algorithm nodes, where both the algorithm node 2 and the algorithm node 3 depend on the algorithm node 1, the algorithm node 4 depends on the algorithm node 2, the algorithm node 5 depends on the algorithm node 3, and the algorithm node 6 depends on the algorithm node 4 and the algorithm node 5.

The target task may be a data processing task that needs to be completed by invoking multiple algorithms, for example, may be an image processing task or an audio processing task.

For example, the manner of obtaining the algorithm directed graph corresponding to the target task may be: obtaining a plurality of processing algorithms required by the target task; determining a dependency relationship between the plurality of processing algorithms; establishing the algorithm directed graph based on the dependency relationship.

The process of obtaining a plurality of processing algorithms required by the target task may be: first determining an initial state and a final state of an object (for example, an image or audio) that needs to be processed by the target task, then dividing the target task into a plurality of stages based on the initial state and the final state, and then determining a processing algorithm to be invoked in each stage. The manner of determining the dependency relationship between the plurality of processing algorithms may be: determining the dependency relationship between the plurality of processing algorithms based on an execution sequence of the plurality of processing algorithms. The manner of establishing the algorithm directed graph based on the dependency relationship may be: adding a directed edge to algorithm nodes corresponding to two processing algorithms having an adjacent dependency relationship, setting an algorithm node that is dependent upon at a starting end of the directed edge, and setting an algorithm node that is dependent to an finishing end of the directed edge. For example, a target task is to process the audio, which goes through the following stages: first filtering the audio, then detecting volume of the filtered audio, then amplifying volume of the audio, and finally performing tone modulation on the audio. It can be seen from the foregoing that the algorithms that need to be invoked by the target task comprise an audio filtering algorithm, a volume detection algorithm, a volume amplification algorithm, and an audio tone modulation algorithm. The dependency relationship between the algorithms is that: the volume detection algorithm relies on the processing result of the audio filtering algorithm, the volume amplification algorithm relies on the processing result of the volume detection algorithm, and the audio tone modulation algorithm relies on the processing result of the volume amplification algorithm. Therefore, the determined algorithm directed graph is shown in FIG. 3. According to the technical solution of the embodiment, an algorithm directed graph is established based on the dependency relationship between the processing algorithms, and the accuracy of the algorithm directed graph may be improved.

S120: group the plurality of algorithm nodes in the algorithm directed graph to obtain a plurality of node groups.

In this embodiment, the basis of execution of the parallel asynchronous framework is first to find the algorithm nodes that may be executed in parallel in the algorithm directed graph. From the perspective of the structure, when the algorithm directed graph has a depth equal to the total number of algorithm nodes, there is no possibility that any two algorithm nodes are executed in parallel at this time. The depth of the algorithm directed graph may be the number of algorithm nodes comprised in the longest link. When the depth of the algorithm directed graph is less than the total number of algorithm nodes, the solution of this embodiment is executed.

For example, algorithm nodes that may be processed in parallel need to be found in an algorithm directed graph, and the algorithm nodes are divided into a group, so as to obtain a plurality of node groups.

Optionally, the manner of grouping the plurality of algorithm nodes in the algorithm directed graph may be: extracting data intersection nodes in the algorithm directed graph; dividing upstream algorithm nodes of the data intersection nodes into a group, dividing downstream algorithm nodes of the data intersection nodes into a group, and taking the data intersection nodes as a group, to obtain a plurality of node groups.

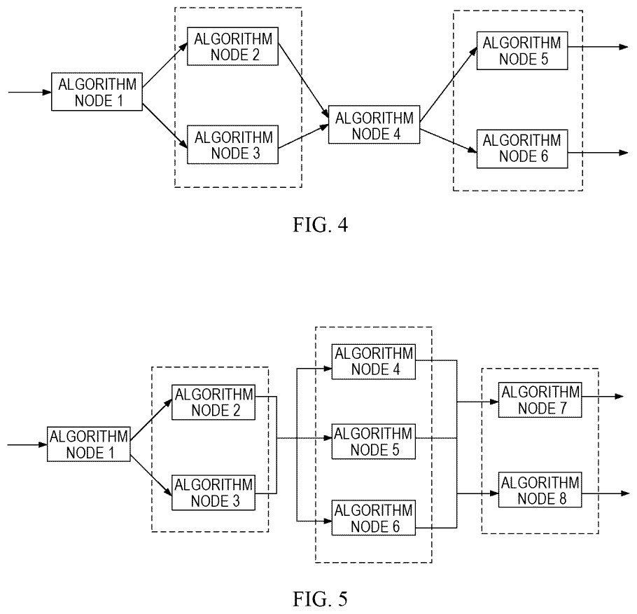

The data intersection node may also be referred to as a “bottleneck” node, and the characteristic of data intersection node is that upstream algorithm nodes of the data intersection node need to communicate with downstream algorithm nodes through the node. The upstream algorithm nodes of the data intersection node may be understood as algorithm nodes between the data intersection node and the previous data intersection node, and the downstream algorithm nodes of the data intersection node may be understood as algorithm nodes between the data intersection node and the next data intersection node. For example, when a plurality of data intersection nodes are determined, the data intersection nodes are divided into a group, and algorithm nodes between adjacent data intersection nodes are divided into a group. For example, FIG. 4 is an example diagram of grouping algorithm nodes in this embodiment. As shown in FIG. 4, node 1 and node 4 are data intersection nodes, both node 2 and node 3 are located between node 1 and node 4, node 5 and node 5 are located downstream of node 4, then node 1 is divided into one group, node 2 and node 3 are divided into a group, node 4 is divided into one group, and node 5 and node 6 are divided into a group. It should be noted that, in the node group obtained by using the foregoing solution, there still exist a plurality of structure forms in the node group, and therefore, the task scheduler is required to screen and schedule the nodes in the node group, thereby implementing parallel in time sequence. In the solution of this embodiment, the algorithm nodes is grouped based on the data intersection point, so that the speed of grouping may be improved.

Optionally, the manner of grouping the plurality of algorithm nodes in the algorithm directed graph may be: obtaining depths of a plurality of algorithm nodes in the algorithm directed graph; dividing the algorithm nodes with the same depth into a group to obtain a plurality of node groups.

The depth of a algorithm node may be understood as the depth of the link where the algorithm node is located. If the algorithm node is located on multiple links, the depths of the algorithm node on each link are obtained separately, and the maximum depth is determined as the final depth. For example, a maximum depth of each algorithm node in the algorithm directed graph is obtained, and algorithm nodes with the same maximum depth are divided into a group, to obtain a plurality of node groups. For example, FIG. 5 is an example diagram of grouping algorithm nodes in this embodiment. As shown in FIG. 5, the depths of the node 2 and the node 3 are the same, the depths of the node 4, the node 5, and the node 6 are the same, and the depths of the node 7 and the node 8 are the same. Thus, node 1 is divided into a group, node 2 and node 3 are divided into a group, node 4, node 5 and node 6 are divided into a group, and node 7 and node 8 are divided into a group. In this embodiment, grouping the algorithm nodes based on the depth may improve the accuracy of the grouping.

S130: schedule the plurality of node groups in series, and schedule a processing algorithm corresponding to at least one algorithm node in the node group in parallel.

The scheduling the plurality of node groups in series may be understood as scheduling each node group in sequence. For example, the manner of scheduling the plurality of node groups in series may be: in response to an execution of the processing algorithm corresponding to the each algorithm node in a currently scheduled node group being completed, continuing to schedule the next node group. In this embodiment, after the processing algorithms corresponding to each algorithm node of the current node group are executed, the next node group may continue to be scheduled, so that the target task is orderly executed, thereby ensuring correctness of the result.

Optionally, the manner of scheduling the plurality of node groups in series, and scheduling the processing algorithm corresponding to at least one algorithm node in the node groups in parallel comprises: creating threads for the plurality of algorithm nodes, respectively, and setting a thread corresponding to an algorithm node not scheduled to be in a waiting state; in response to scheduling the current node group, starting a thread corresponding to the current node group, to enable the started thread to execute the processing algorithm corresponding to the at least one algorithm node in the current node group.

In this embodiment, after creating threads for the plurality of algorithm nodes respectively, the entire algorithm directed graph is automatically executed by the Wait and Signal mechanism provided by the operating system. For each algorithm node, the input dependency on the previous node makes it automatically enter the waiting state after initialization, and the execution-completed algorithm node after outputing processing result will trigger the start of the following algorithm node thread. under the rule framework, since the source node (Source) of the algorithm directed graph does not depend on any previous node, it becomes the first executed node, and after the execution, the execution of the plurality of following nodes will be sequentially triggered until the execution of the entire algorithm directed graph ends.

For example, after creating threads for the plurality of algorithm nodes respectively, the thread corresponding to the starting node group is started first, the processing algorithm corresponding to the at least one algorithm node in the starting node group is executed in parallel, and the thread corresponding to the following node group enters the waiting state. After the execution of one processing algorithm in the starting node group is completed, the thread corresponding to the next node group is started, so that the starting thread executes the processing algorithms corresponding to the algorithm nodes in the current node group in parallel, and so on, until the entire algorithm directed graph is executed. In this embodiment, threads are created in advance for a plurality of algorithm nodes, and then the entire process is controlled by the operating system, which has the advantage that the execution process may be directed to different platforms.

Optionally, the method further comprises: setting a cache pool; storing a processing result of the processing algorithm corresponding to each algorithm node to the cache pool, to enable a following algorithm node to read the processing result from the cache pool for processing.

In this embodiment, the inter-group information may use a unified cache pool (BufferContainer) to share the input and outout information, thereby avoiding waste of computing resources.

Optionally, the manner of scheduling the plurality of node groups in series, and scheduling the processing algorithm corresponding to at least one algorithm node in the node groups in parallel may be: in response to scheduling a current node group, creating and starting a thread corresponding to the current node group, to enable the started thread to execute a processing algorithm corresponding to at least one algorithm node in the current node group; in response to the execution of the processing algorithm corresponding to the algorithm node is completed, terminating a thread corresponding to the algorithm node, and storing the processing result in a first queue.

The first queue may be used to store a processing result of the algorithm node. In this embodiment, implementation allocation and termination of the thread are implemented through the task scheduler, and the processing algorithm corresponding to the algorithm node is executed by the thread pool allocation thread.

The process of creating and starting the thread corresponding to the current node group, to enable the started thread to execute the processing algorithm corresponding to at least one algorithm node in the current node group may be: reading a processing result from the first queue, and determining a current node group based on the processing result; writing algorithm node information comprised in the current node group into a second queue; creating and starting a thread based on the algorithm node information in the second queue, to enable the started thread to execute a processing algorithm corresponding to the algorithm node information.

The second queue is used to store algorithm node information, that is, a node task.

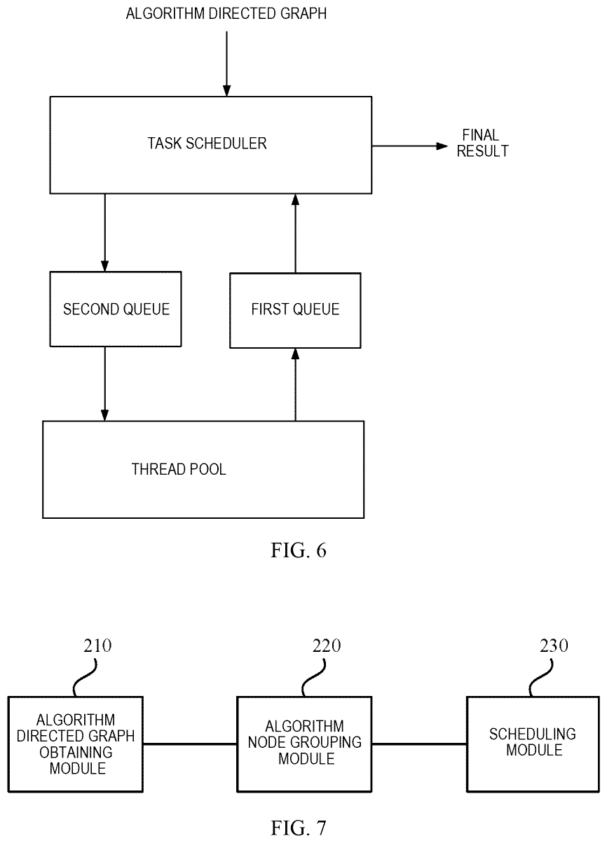

For example, FIG. 6 is an example diagram of an algorithm scheduling in this embodiment. As shown in FIG. 6, the task scheduler reads the processing result from the first queue, determines the following node group of the read processing result based on the priority in the algorithm directed graph, writes the algorithm node information of the following node group into the second queue, the thread pool creates and allocates the thread according to the algorithm node information in the first queue to execute the processing algorithm in the following node group, and writes the processing result of each processing algorithm into the first queue until the execution of the algorithm directed graph is completed, and outputs the final result. According to the solution of the embodiment, the starting thread is created to execute the processing algorithm corresponding to the algorithm node, thus waste of resources may be avoided, and the execution efficiency of the algorithm may be improved.

According to the technical solution of the embodiment of the disclousure, an algorithm directed graph corresponding to a target task is obtained, wherein the algorithm directed graph comprises a plurality of algorithm nodes; the plurality of algorithm nodes in the algorithm directed graph are grouped to obtain a plurality of node groups; the plurality of node groups are scheduled in series, and a processing algorithm corresponding to at least one algorithm node in the node group is scheduled in parallel. According to the scheduling method provided by the embodiment of the disclosure, after the plurality of algorithm nodes in the algorithm directed graph are grouped, the plurality of node group is scheduled in series, the processing algorithm corresponding to the at least one algorithm node in the node group is scheduled in parallel, thus the throughput rate and the calculation efficiency during the target task processing can be improved.

FIG. 7 is a schematic structural diagram of a scheduling apparatus according to an embodiment of the disclosure. As shown in FIG. 7, the apparatus comprises:

an algorithm directed graph obtaining module 210, configured to obtain an algorithm directed graph corresponding to a target task, the algorithm directed graph comprising a plurality of algorithm nodes;

an algorithm node grouping module 220, configured to group the plurality of algorithm nodes in the algorithm directed graph to obtain a plurality of node groups;

a scheduling module 230, configured to schedule the plurality of node groups in series, and schedule a processing algorithm corresponding to at least one algorithm node in the node groups in parallel.

Optionally, the algorithm directed graph obtaining module 210 is configured to establish the algorithm directed graph by:
obtaining a plurality of processing algorithms required by the target task;
determining a dependency relationship between the plurality of processing algorithms;
establishing the algorithm directed graph based on the dependency relationship.

Optionally, the algorithm node grouping module 220 is configured to group the plurality of algorithm nodes in the algorithm directed graph to obtain a plurality of node group by:
extracting data intersection nodes in the algorithm directed graph;
dividing upstream algorithm nodes of the data intersection nodes into a group, dividing downstream algorithm nodes of the data intersection nodes into a group, and taking the data intersection nodes as a group, to obtain a plurality of node groups.

Optionally, the algorithm node grouping module 220 is further configured to group the plurality of algorithm nodes in the algorithm directed graph to obtain a plurality of node groups by:
obtaining depths of a plurality of algorithm nodes in the algorithm directed graph;
dividing the algorithm nodes with the same depth into a group to obtain a plurality of node groups.

Optionally, the scheduling module 230 is configured to schedule the plurality of node groups in series by:
in response to an execution of the processing algorithm corresponding to the at least one algorithm node in a currently scheduled node group being completed, continuing to schedule the next node group.

Optionally, the scheduling module 230 is configured to schedule the plurality of node groups in series, and schedule the processing algorithm corresponding to at least one algorithm node in the node groups in parallel by:
creating threads for the plurality of algorithm nodes, respectively, and setting a thread corresponding to an algorithm node not scheduled to be in a waiting state;
in response to scheduling the current node group, starting a thread corresponding to the current node group, to enable the started thread to execute the processing algorithm corresponding to the at least one algorithm node in the current node group.

Optionally, the apparatus further comprises: a cache pool setting module, configured for:
setting a cache pool;
storing a processing result of the processing algorithm corresponding to the at least one algorithm node to the cache pool, to enable a following algorithm node to read the processing result from the cache pool for processing.

Optionally, the scheduling module 230 is configured to schedule the plurality of node groups in series, and schedule the processing algorithm corresponding to at least one algorithm node in the node groups in parallel by:
in response to scheduling a current node group, creating and starting a thread corresponding to the current node group, to enable the started thread to execute a processing algorithm corresponding to at least one algorithm node in the current node group;
in response to the execution of the processing algorithm corresponding to the algorithm node is completed, terminating a thread corresponding to the algorithm node, and storing the processing result in a first queue.

Optionally, the scheduling module 230 is configured to creat and start the thread corresponding to the current node group, to enable the started thread to execute the processing algorithm corresponding to at least one algorithm node in the current node group, by:
reading a processing result from the first queue, and determining a current node group based on the processing result;
writing algorithm node information comprised in the current node group into a second queue;
creating and starting a thread based on the algorithm node information in the second queue, to enable the started thread to execute a processing algorithm corresponding to the algorithm node information.

The foregoing apparatus may perform the method provided in all the foregoing embodiments of the disclosure, and has functional modules and beneficial effects corresponding to the foregoing method. For technical details not described in detail in this embodiment, reference may be made to the method provided by all the foregoing embodiments of the present disclosure.

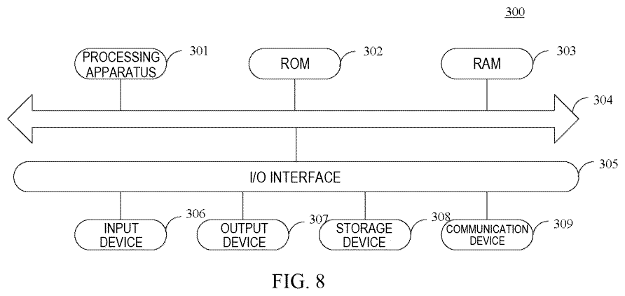

Reference now is made to FIG. 8, which is a schematic structural diagram of an electronic device 300 suitable for implementing embodiments of the disclosure. The electronic device in the embodiments of the disclosure may include a mobile terminal such as a mobile phone, a notebook computer, a digital broadcast receiver, a personal digital assistant (PDA), a portable Android device (PAD), a portable media player (PMP), an in-vehicle terminal (for example, an in-vehicle navigation terminal), and a fixed terminal such as a digital TV, a desktop computer, or the like, or various forms of servers, such as a standalone server or a server cluster. The electronic device shown in FIG. 8 is merely an example.

As shown in FIG. 8, the electronic device 300 may include a processing device (for example, a central processing unit, a graphics processor, etc.) 301, and the processing apparatus 301 may perform various appropriate actions and processing according to a program stored in a read-only memory (ROM) 302 or a program loaded into a random access memory (RAM) 303 from a storage device 308. In the RAM 303, various programs and data required by the operation of the electronic device 300 are also stored. The processing apparatus 301, the ROM 302, and the RAM 303 are connected to each other through a bus 304. An input/output (I/O) interface 305 is also connected to the bus 304.

Generally, the following devices may be connected to the I/O interface 305: an input device 306 including, for example, a touch screen, a touch pad, a keyboard, a mouse, a camera, a microphone, an accelerometer, a gyroscope, and the like; an output device 307 including, for example, a liquid crystal display (LCD), a speaker, a vibrator, and the like; a storage device 308 including, for example, a magnetic tape, a hard disk, and the like; and a communication device 309. The communication device 309 may allow the electronic device 300 to communicate wirelessly or wired with other devices to exchange data. While FIG. 8 shows an electronic device 300 having various devices, it should be understood that it is not required to implement or have all illustrated devices. More or fewer devices may alternatively be implemented or provided.

In an embodiment, the process described above with reference to the flowchart may be implemented as a computer software program according to an embodiment of the present disclosure. For example, embodiments of the disclosure comprise a computer program product comprising a computer program embodied on a computer readable medium, the computer program comprising program code for performing a scheduling method. In such embodiments, the computer program may be downloaded and installed from the network through the communication device 309, or installed from the storage device 308, or from the ROM 302. When the computer program is executed by the processing apparatus 301, the foregoing functions defined in the method of the embodiments of the present disclosure are performed.

It should be noted that the computer readable medium described above may be a computer readable signal medium, a computer readable storage medium, or a combination of the both. The computer-readable storage medium may be, for example, an electrical, magnetic, optical, electromagnetic, infrared, or semiconductor system, apparatus, or device, or a combination thereof. Examples of the computer-readable storage medium may include: an electrical connection having one or more wires, a portable computer diskette, a hard disk, a random access memory (RAM), a read-only memory (ROM), an erasable programmable read-only memory (such as an electronic programmable read-only memory (EPROM) or flash memory), an optical fiber, a portable compact disc read-only memory (CD-ROM), an optical storage device, a magnetic storage device, or a suitable combination thereof. In the disclosure, a computer-readable storage medium may be a tangible medium containing or storing a program that may be used by or in connection with an instruction execution system, apparatus, or device. In the disclosure, a computer readable signal medium may include a data signal propagated in baseband or as part of a carrier, where the computer readable program code is carried. Such propagated data signals may take a variety of forms, including electromagnetic signals, optical signals, or suitable combinations thereof. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted by any suitable medium, including wires, optical cables, radio frequency (RF), and the like, or suitable combinations thereof.

In some implementations, the client, server may communicate using any currently known or future developed network protocol, such as Hypertext Transfer Protocol (HTTP), and may be interconnected with any form or medium of digital data communication (e.g., a communication network). Examples of communication networks include Local Area Networks (LANs), Wide Area Networks (WANs), Internet networks (e.g., the Internet), and peer-to-peer networks (e.g., ad hoc peer-to-peer networks), as well as currently known or future developed networks.

The computer-readable medium described above may be comprised in the electronic device; or may be separately present without being assembled into the electronic device.

The computer readable medium carries at least one program, and when the at least one program is executed by the electronic device, the electronic device is caused to: obtain an algorithm directed graph corresponding to a target task, wherein the algorithm directed graph comprises a plurality of algorithm nodes; group the plurality of algorithm nodes in the algorithm directed graph to obtain a plurality of node groups; schedule the plurality of node groups in series, and schedule a processing algorithm corresponding to at least one algorithm node in the node group in parallel.

Computer program code for performing the operations of the present disclosure may be written in one or more programming languages, including, but not limited to, object-oriented programming languages such as Java, Smalltalk, C++, and conventional procedural programming languages, such as the “C” language or similar programming languages. The program code may execute entirely on a user computer, partially on a user computer, as a stand-alone software package, partially on a user computer and partially on a remote computer, or entirely on a remote computer or server. In the case of a remote computer involved, the remote computer may be connected to the user computer through any kind of network, including a local area network (LAN) or a wide area network (WAN), or may be connected to an external computer (e.g., connected through the Internet using an Internet service provider).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that comprises one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. The name of the module does not constitute a limitation on the unit itself in some cases.

The functions described above may be performed, at least in part, by one or more hardware logic components. For example, without limitation, exemplary types of hardware logic components that may be used comprise: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may comprise electronic, magnetic, optical, electromagnetic, infrared, or semiconductor systems, apparatus, or devices, or any suitable combination of the foregoing. The examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

According to one or more embodiments of the present disclosure, an embodiment of the present disclosure discloses a scheduling method, comprising:
obtaining an algorithm directed graph corresponding to a target task, the algorithm directed graph comprising a plurality of algorithm nodes;
grouping the plurality of algorithm nodes in the algorithm directed graph to obtain a plurality of node groups;
scheduling the plurality of node groups in series, and scheduling a processing algorithm corresponding to at least one algorithm node in the node group in parallel.

Optionally, obtaining the algorithm directed graph corresponding to the target task comprises:
obtaining a plurality of processing algorithms required by the target task;
determining a dependency relationship between the plurality of processing algorithms;
establishing the algorithm directed graph based on the dependency relationship.

Optionally, grouping the plurality of algorithm nodes in the algorithm directed graph comprises:
extracting data intersection nodes in the algorithm directed graph;
dividing upstream algorithm nodes of the data intersection nodes into a group, dividing downstream algorithm nodes of the data intersection nodes into a group, and taking the data intersection nodes as a group, to obtain a plurality of node groups.

Optionally, grouping the plurality of algorithm nodes in the algorithm directed graph comprises:
obtaining depths of a plurality of algorithm nodes in the algorithm directed graph;
dividing the algorithm nodes with the same depth into a group to obtain a plurality of node groups.

Optionally, scheduling the plurality of node groups in series comprises:
in response to an execution of the processing algorithm corresponding to the at least one algorithm node in a currently scheduled node group being completed, continuing to schedule the next node group.

Optionally, scheduling the plurality of node groups in series, and scheduling the processing algorithm corresponding to at least one algorithm node in the node groups in parallel comprises:
creating threads for the plurality of algorithm nodes, respectively, and setting a thread corresponding to an algorithm node not scheduled to be in a waiting state;
in response to scheduling the current node group, starting a thread corresponding to the current node group, to enable the started thread to execute the processing algorithm corresponding to the at least one algorithm node in the current node group.

Optionally, the method further comprises:
setting a cache pool;
storing a processing result of the processing algorithm corresponding to the at least one algorithm node to the cache pool, to enable a following algorithm node to read the processing result from the cache pool for processing.

Optionally, scheduling the plurality of node groups in series, and scheduling the processing algorithm corresponding to at least one algorithm node in the node groups in parallel comprises:
in response to scheduling a current node group, creating and starting a thread corresponding to the current node group, to enable the started thread to execute a processing algorithm corresponding to at least one algorithm node in the current node group;
in response to the execution of the processing algorithm corresponding to the algorithm node is completed, terminating a thread corresponding to the algorithm node, and storing the processing result in a first queue.

Optionally, creating and starting the thread corresponding to the current node group, to enable the started thread to execute the processing algorithm corresponding to at least one algorithm node in the current node group comprises:
reading a processing result from the first queue, and determining a current node group based on the processing result;
writing algorithm node information comprised in the current node group into a second queue;
creating and starting a thread based on the algorithm node information in the second queue, to enable the started thread to execute a processing algorithm corresponding to the algorithm node information.

It should be understood that the steps may be reordered, added, or deleted using the various forms of flows shown above. For example, the steps described in the disclosure may be performed in parallel, in sequence or in different orders, as long as the results expected by the technical solutions of the disclosure can be implemented.

1-12. (canceled)

13. A scheduling method, comprising:
obtaining an algorithm directed graph corresponding to a target task, the algorithm directed graph comprising a plurality of algorithm nodes;
grouping the plurality of algorithm nodes in the algorithm directed graph to obtain a plurality of node groups; and
scheduling the plurality of node groups in series, and scheduling a processing algorithm corresponding to at least one algorithm node in the node group in parallel.

14. The method of claim 13, wherein obtaining the algorithm directed graph corresponding to the target task comprises:
obtaining a plurality of processing algorithms required by the target task;
determining a dependency relationship between the plurality of processing algorithms; and
establishing the algorithm directed graph based on the dependency relationship.

15. The method of claim 13, wherein grouping the plurality of algorithm nodes in the algorithm directed graph comprises:
extracting data intersection nodes in the algorithm directed graph; and
dividing upstream algorithm nodes of the data intersection nodes into a group, dividing downstream algorithm nodes of the data intersection nodes into a group, and taking the data intersection nodes as a group, to obtain a plurality of node groups.

16. The method of claim 13, wherein grouping the plurality of algorithm nodes in the algorithm directed graph comprises:
obtaining depths of a plurality of algorithm nodes in the algorithm directed graph; and
dividing the algorithm nodes with the same depth into a group to obtain a plurality of node groups.

17. The method of claim 13, wherein scheduling the plurality of node groups in series comprises:
in response to an execution of the processing algorithm corresponding to the at least one algorithm node in a currently scheduled node group being completed, continuing to schedule the next node group.

18. The method of claim 13, wherein scheduling the plurality of node groups in series, and scheduling the processing algorithm corresponding to at least one algorithm node in the node groups in parallel comprises:
creating threads for the plurality of algorithm nodes, respectively, and setting a thread corresponding to an algorithm node not scheduled to be in a waiting state; and
in response to scheduling the current node group, starting a thread corresponding to the current node group, to enable the started thread to execute the processing algorithm corresponding to the at least one algorithm node in the current node group.

19. The method of claim 18, further comprising:
setting a cache pool; and
storing a processing result of the processing algorithm corresponding to the at least one algorithm node to the cache pool, to enable a following algorithm node to read the processing result from the cache pool for processing.

20. The method of claim 13, wherein scheduling the plurality of node groups in series, and scheduling the processing algorithm corresponding to at least one algorithm node in the node groups in parallel comprises:
in response to scheduling a current node group, creating and starting a thread corresponding to the current node group, to enable the started thread to execute a processing algorithm corresponding to at least one algorithm node in the current node group; and
in response to the execution of the processing algorithm corresponding to the algorithm node is completed, terminating a thread corresponding to the algorithm node, and storing the processing result in a first queue.

21. The method of claim 20, wherein creating and starting the thread corresponding to the current node group, to enable the started thread to execute the processing algorithm corresponding to at least one algorithm node in the current node group comprises:
reading a processing result from the first queue, and determining a current node group based on the processing result;
writing algorithm node information comprised in the current node group into a second queue; and
creating and starting a thread based on the algorithm node information in the second queue, to enable the started thread to execute a processing algorithm corresponding to the algorithm node information.

22. An electronic device, comprising:
one or more processing devices;
a storage device configured to store one or more programs;
wherein the one or more programs, when executed by the one or more processing devices, cause the one or more processing devices to perform acts comprising:
obtaining an algorithm directed graph corresponding to a target task, the algorithm directed graph comprising a plurality of algorithm nodes;
grouping the plurality of algorithm nodes in the algorithm directed graph to obtain a plurality of node groups; and
scheduling the plurality of node groups in series, and scheduling a processing algorithm corresponding to at least one algorithm node in the node group in parallel.

23. The electronic device of claim 22, wherein obtaining the algorithm directed graph corresponding to the target task comprises:
obtaining a plurality of processing algorithms required by the target task;
determining a dependency relationship between the plurality of processing algorithms; and
establishing the algorithm directed graph based on the dependency relationship.

24. The electronic device of claim 22, wherein grouping the plurality of algorithm nodes in the algorithm directed graph comprises:
extracting data intersection nodes in the algorithm directed graph; and
dividing upstream algorithm nodes of the data intersection nodes into a group, dividing downstream algorithm nodes of the data intersection nodes into a group, and taking the data intersection nodes as a group, to obtain a plurality of node groups.

25. The electronic device of claim 22, wherein grouping the plurality of algorithm nodes in the algorithm directed graph comprises:
obtaining depths of a plurality of algorithm nodes in the algorithm directed graph; and
dividing the algorithm nodes with the same depth into a group to obtain a plurality of node groups.

26. The electronic device of claim 22, wherein scheduling the plurality of node groups in series comprises:
in response to an execution of the processing algorithm corresponding to the at least one algorithm node in a currently scheduled node group being completed, continuing to schedule the next node group.

27. The electronic device of claim 22, wherein scheduling the plurality of node groups in series, and scheduling the processing algorithm corresponding to at least one algorithm node in the node groups in parallel comprises:
creating threads for the plurality of algorithm nodes, respectively, and setting a thread corresponding to an algorithm node not scheduled to be in a waiting state; and
in response to scheduling the current node group, starting a thread corresponding to the current node group, to enable the started thread to execute the processing algorithm corresponding to the at least one algorithm node in the current node group.

28. The electronic device of claim 27, wherein the acts further comprise:
setting a cache pool; and
storing a processing result of the processing algorithm corresponding to the at least one algorithm node to the cache pool, to enable a following algorithm node to read the processing result from the cache pool for processing.

29. The electronic device of claim 22, wherein scheduling the plurality of node groups in series, and scheduling the processing algorithm corresponding to at least one algorithm node in the node groups in parallel comprises:
in response to scheduling a current node group, creating and starting a thread corresponding to the current node group, to enable the started thread to execute a processing algorithm corresponding to at least one algorithm node in the current node group; and
in response to the execution of the processing algorithm corresponding to the algorithm node is completed, terminating a thread corresponding to the algorithm node, and storing the processing result in a first queue.

30. The electronic device of claim 29, wherein creating and starting the thread corresponding to the current node group, to enable the started thread to execute the processing algorithm corresponding to at least one algorithm node in the current node group comprises:
reading a processing result from the first queue, and determining a current node group based on the processing result;
writing algorithm node information comprised in the current node group into a second queue; and
creating and starting a thread based on the algorithm node information in the second queue, to enable the started thread to execute a processing algorithm corresponding to the algorithm node information.

31. A non-transitory computer-readable medium having a computer program stored thereon, wherein the computer program, when executed by a processing device, causes the processing device to perform acts comprising:
obtaining an algorithm directed graph corresponding to a target task, the algorithm directed graph comprising a plurality of algorithm nodes;
grouping the plurality of algorithm nodes in the algorithm directed graph to obtain a plurality of node groups; and
scheduling the plurality of node groups in series, and scheduling a processing algorithm corresponding to at least one algorithm node in the node group in parallel.

32. The non-transitory computer-readable medium of claim 31, wherein obtaining the algorithm directed graph corresponding to the target task comprises:
obtaining a plurality of processing algorithms required by the target task;
determining a dependency relationship between the plurality of processing algorithms; and
establishing the algorithm directed graph based on the dependency relationship.
